(19) United States
(12) Patent Application Publication
(10) Pub. No.: US 2008/0244939 A1
(43) Pub. Date: Oct. 9, 2008

(54) HANGING BASKET COLLAR

(76) Inventor: Eric A. Rosendall, Grand Ledge, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/697,745

(22) Filed: Apr. 9, 2007

(51) Int. Cl. G09F 1/00

(52) U.S. Cl. 40/124.07

(57) ABSTRACT

A hanging basket display collar includes at least one pop-put panel when the conical collar is formed. In one embodiment, the pop-out panel is formed by two facing semicircular die cuts which define a generally circular pop-out panel coupled by integral hinges at the top and bottom edges, such that, when the collar is formed, the disk-shaped pop-out panel remains flat and extends in a plane spaced outwardly from the conical surface of the collar. A plurality of such pop-out panels can he provided and include printed plant identification and care information thereon.

### BACKGROUND OF THE INVENTION

The present invention relates to a collar which extends over the hook and wires of a hanging basket used in merchandising live plants.

There exists numerous hanger collars which have been used in a variety of applications for advertising or protective purposes in connection with hangers, such as garment hangers. U.S. Pat. No. 2,880,928 is illustrative of a cylindrical collar which fits over the hook of a hanger and provides protection for the collared area of an item placed on the hanger. Similarly, collars have been placed on a variety of containers, such as milk containers, for advertising and providing, information as to the nature of the contents. U.S. Pat. Nos. 1,829,915 and 2,214,436 are illustrative of such collars.

When merchandising five plants, frequently they are placed in hanging baskets, which are suspended on a hook with wires extending to the rim of the pot containing the live flowers. With such merchandising, plant stakes can be inserted directly into the soil, however, they frequently can be easily removed or obscured by the foliage of the plant itself and, therefore, do not provide an ideal medium for the communication of information to the customer. Also, plant locking tags can be inserted into slots in the plant pot itself, as shown, for example, by U.S. Pat. No. 7,076,900. A hanger tag also has been employed for use with hanging baskets, U.S. Pat. No. 6,145,233 is representative of such a tag.

Another manner by which the plants can be identified and care instructions can be communicated to the consumer is through the use of a banging basket collar. One such hanging collar is disclosed in U.S. Pat. No. D 501,514, issued to the Assignee of the present invention. Although such a collar provides a convenient location for the display of information regarding the plant on which it is placed, it requires additional steps for its application, namely, the folding of the collar into flat panels. Hanging baskets typically use either three or four wires for their suspension from a hook. Thus, folded collars, in order to conform to the different number of suspension wires must have either three panels or other structure to allow the collar to nest on the suspension wires. Accordingly, it would he desirable to provide an improved hanging basket collar which eliminates both the necessity of additional folding steps for application of the collar to a basket and the need for two different designs depending upon the number of suspension wires. Also, it is desirable to provide a collar which provides plant information carried thereon in an eye-catching manner.

### SUMMARY OF THE INVENTION.

This invention satisfies this need by providing a display collar comprising a curved body and a pop-out display panel coupled to a body by hinges integral with the body, with the hinges aligned on an axis orthogonal to the radius of curvature of the body. In a preferred embodiment, the collar is a hanging basket collar which includes at least one pop-out panel with plant identification indicia for display when the continuous collar is placed around the wires of a hanging basket. In one embodiment of the invention, the pop-out panel is formed by two facing semicircular die cuts in a polymeric material which define a generally circular pop-out panel coupled at the top and bottom by integral hinges to the polymeric material, such that, when the collar is formed, the disk-shaped pop-out panel remains flat and extends in a plane spaced outwardly from the conical surface of the collar. In another embodiment of the invention, a plurality of such pop-out panels are provided and, in a most preferred embodiment, two opposed pop-out panels are provided. The collar body and pop-out panels carry printed indicia, such as photographs of the plant, plant care instructions, pricing information, and the like, for use by the consumer in making a purchasing decision and for subsequent plant care assistance.

These and other features, objects and advantages of the present invention will become apparent upon reading the following description thereof together with reference to the accompanying drawings.

### BRIEF DESCRIPTION OF THE DRAWINGS

FIG. 1 is a perspective view of a hanging basket collar of the present invention;

FIG. 2 is a front elevational view of the collar shown in FIG. 1, shown in its installed condition;

FIG. 3 is a right side elevational view of the collar shown in FIG. 1;

FIG. 4 is a left side elevational view of the collar shown in FIG. 1;

Fig, 5 is a top plan view of the collar shown in FIG. 1;

FIG. 6 is a bottom plan view of the collar shown in FIG. 1; and

FIG. 7 is a plan view of the die cut structure defining the collar shown in FIGS. 1-6.

### DETAILED DESCRIPTION OF THE PREFERRED EMBODIMENT

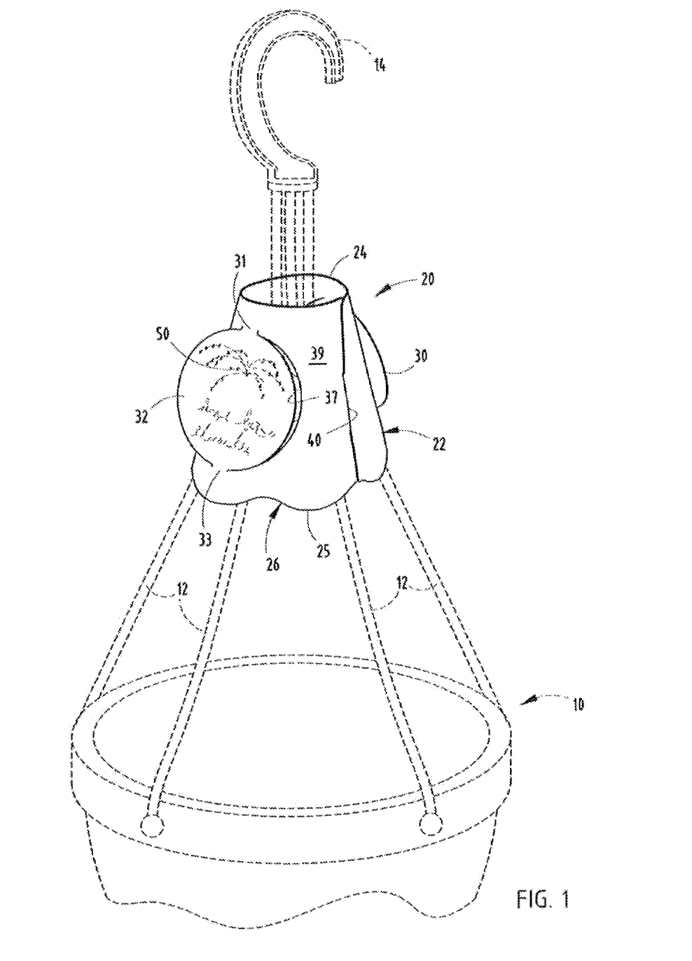

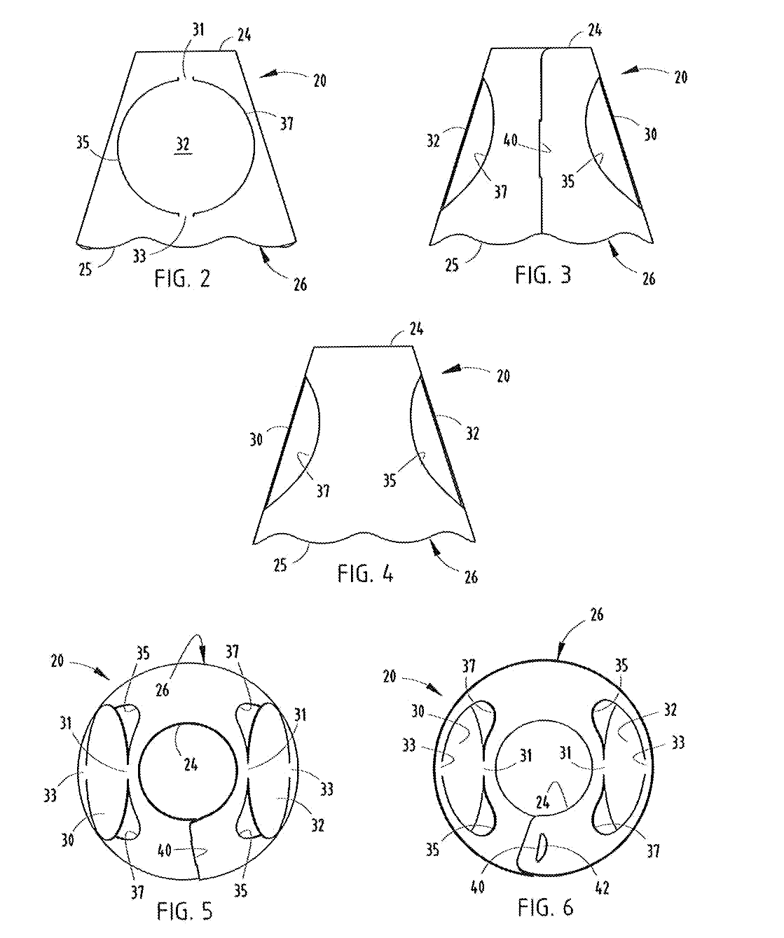

Referring initially to FIGS. 1-6, there is shown in phantom form in FIG. 1 a hanging basket 10 of the type which is employed for merchandising live plants at various retail outlets. Basket 10 typically includes three or four hanging wires 12 which can be wires or plastic members which are integrally molded with a hook 14 for the hanging of plants in a home or office environment.

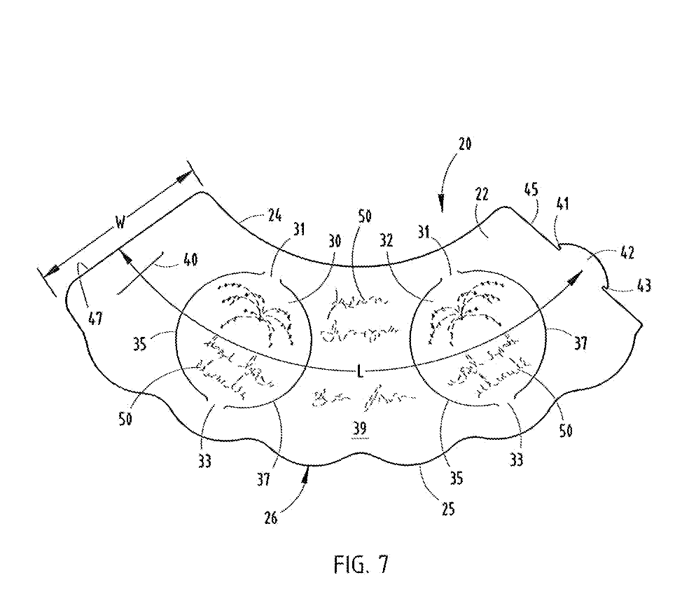

A hanging basket collar 20 of the present invention is installed over hook 14 and supported on wires 12, as best seen in FIG. 1, and comprises a generally conical body 22 having a circular upper edge 24 (when installed) and a scalloped lower edge 26, which is generally circular and has a diameter greater than that of upper edge 24. Edge 26 is scalloped with outwardly extending curved projections 25. The collar, as described in greater detail below in connection with FIG. 7, is integrally formed from a die cut member of polymeric material, such as high density polyethylene (HDPE), having a thickness of about 10 to about 20 mills and includes, in the preferred embodiment shown in FIGS. 1-6, a pair of generally circular pop-out panels 30 and 32. The generally circular pop-out panels are held to the body 22 of collar 20 by integral upper and lower hinges 31 and 33 and are formed by opposed semicircular die cuts 35 and 37, which each extend through an arc less than 180° to leave the hinges 31 and 33 on each of the pop-out panels 30 and 32. By aligning integral hinges 31, 33 on an axis orthogonal to the radius of curvature of the collar as the collar is curved during assembly, the edges of panels 30, 32 adjacent die cuts 35, 37 extend (or pop-out) from the surface of the collar. The collar also includes a locking slot 40 and a locking tab 42 which extends through slot 40, as shown in FIG. 6, to assemble the conical collar for installation on a hanging basket, such as seen in FIG. 1.

The collar is formed from a planar panel of material 22, as best seen in FIG. 7, which has an upper edge 24 having a first radios of curvature, such as about 3.75 inches, and a lower scalloped edge 26 having a mean radius of curvature of about 7.5 inches leaving the overall width W (in FIG. 7) of collar 20 of about 3.65 inches. The arcuate length in FIG. 7 of collar 20 is from about 10 to about 12 inches, and preferably about 10.5 inches, in one preferred embodiment. In such embodiment, the diameter of the circular pop-out panels 30 and 32 are about 2.75 inches and the die cuts 35, 37 forming the pop-out panels 30, 32 each circumscribe an arc of about 150° to about 160° to define the generally circular pop-out panels 30 and 32. When the flat body 22 defining the conical collar 20 is formed into the conical shape shown in FIGS. 1-6 and the tab 42 is inserted, into slot 40 as shown, the panels 30 and 32 pop-out and extend in a plane outwardly from the otherwise conical surface 39 of the collar 20, as best illustrated in FIGS. 1 and 6.

Tab 42 is relatively short and wide to improve the locking of the collar edges 45 and 47 together. Tab 42 includes opposed tabs 41 and 43 spaced from the edge 45 of body 22 a distance sufficient to interlock the tab 42 within slot 40 adjacent the opposite edge 47 of body 22. In a preferred embodiment of the invention, slot 40 had a width of about 1.20 inches while the distance between tabs 41 and 43 was 1.3 inches. The resilient tab 42 deflects sufficiently for the insertion of the tab 42 into slot 40, but, once inserted, the collar remains firmly locked in the conical shape shown in FIGS. 1-6.

Printed indicia 50, such as illustrated in phantom lines on panel 30 in FIG. 1, identifies the plant and its care and can be included on the body 39 of collar 20 as well as on the second pop-out panel 32, as shown in FIG. 7. Thus, with the hanging basket collar 20 of the present invention, an easily assembled collar is provided which can be used with hanging baskets with different numbers of suspending wires. The collar has one or more noticeable pop-out panels which extend from the body of the conical collar to provide an attraction which stands out and easily catches the consumer's eye for providing information as to the plant being purchased as well as providing information regarding the care of the plant, such as amount of sunlight required, watering instructions, and the like. Collar 20 may also include information identifying the retailer and may carry a retailer's trademarks and logos, as well as other helpful information.

The collar may include a single pop-out panel or multiple pop-out panels, such as the two opposed ones shown in the figures. Also, smaller multiple panels may be employed, although one to three and most preferably two pop-out panels provide the greatest attraction to the information contained in these panels. The geometry of the pop out panels also may be varied by making them oval, square, rectangular, triangular, or the like, as long as they are integrally hinged to the conical body of the collar. Also, the pop-out display provided by this invention may be used with a body other than a conical shape, as long as the body is curvilinear when assembled for use and the pop-out panel(s) is hinged along an axis orthogonal to the radius of curvature of the body. By providing a pop-out panel which has a surface plane which extends outwardly front the plane of the curved collar, the information presented thereon is eye-catching and conveniently located for access.

It will become apparent to those skilled in the art that these and other modifications to the collar of the present invention may be made without departing from the spirit or scope of the invention as defined by the appended claims.

The invention claimed is:

1. A display collar comprising:
a planar panel of material formed into a curved body; and
a pop-out display panel coupled to said body by hinges integral with said body, said hinges aligned on an axis orthogonal to a radius of curvature of said body.

2. The collar as defined in claim 1 wherein said body is conical.

3. The collar as defined in claim 2 wherein said pop-out panel is generally circular.

4. The collar as defined in claim 3 wherein said pop-out panel includes printed indicia thereon.

5. The collar as defined in claim 4 wherein said collar is dimensioned to fit over a hanger of a hanging basket.

6. The collar as defined in claim 5 wherein said collar is made of a polymeric material.

7. The collar as defined in claim 6 wherein said panel of material includes a wide locking tab and a mating slot at opposite edges to hold said material in said conical shape.

8. A collar comprising:
a body having an upper edge defined by a first radius of curvature and a lower edge defined by a second radius of curvature, said body circumscribing an arc having opposed edges extending generally orthogonally to said upper and lower edges, said body including a locking tab and mating slot for coupling said opposed edges to one another to form said body into a conical shape; and
wherein said body includes opposed semicircular die cuts, such that as said body is formed into a conical shape, the die cuts allow a generally circular section of the panel to extend from the conical surface of the panel to define a pop-out display panel.

9. The collar as defined in claim 8 and further including a second pair of opposed semicircular die cuts to define a second pop-out display panel spaced from said first named display panel.

10. The collar as defined in claim 8 wherein said pop-out panel includes printed indicia thereon.

11. The collar as defined in claim 8 wherein said collar is dimensioned to fit over a hanger of a hanging basket.

12. The collar as defined in claim 11 wherein said collar is made of a polymeric material.

13. A conical collar for a hanging basket comprising:
a conical shaped body having upper and lower generally circular edges and a display panel interposed between said upper and lower edges and having a surface which is generally planar and extends outwardly from the conical surface of said collar.

14. The collar as defined in claim 13 wherein said panel is generally circular.

15. The collar as defined in claim 14 wherein said panel includes printed indicia thereon.

16. The collar as defined in claim 15 wherein said collar is dimensioned to fit over a hanger of a hanging basket.

17. The collar as defined in claim 16 wherein said collar is made of a polymeric material.

18. The collar as defined in claim 17 wherein said body is formed of an arcuate-shaped panel.

19. The collar as defined in claim 18 wherein said panel includes a relatively wide locking tab along one edge and a mating slot adjacent an opposite edge.

20. The collar as defined in claim 19 wherein said lower edge of said body is scalloped.
